(19) United States
(12) Patent Application Publication
(10) Pub. No.: US 2025/0170839 A1
(43) Pub. Date: May 29, 2025

(54) MULTILAYER BELT, MEDIUM TRANSPORT DEVICE, AND RECORDING DEVICE

(71) Applicant: SEIKO EPSON CORPORATION, TOKYO (JP)

(72) Inventors: Yu KITAHARA, MATSUMOTO-SHI (JP); Masayuki SHIBATA, CHIKUMA-SHI (JP); Takuru SUEHIRO, SHIOJIRI-SHI (JP); Kai YAMADA, SHIOJIRI-SHI (JP)

(21) Appl. No.: 18/963,572

(22) Filed: Nov. 28, 2024

(30) Foreign Application Priority Data
Nov. 28, 2023 (JP) 2023-200479
Nov. 28, 2023 (JP) 2023-200539

(51) Int. Cl. B41J 13/08; B41J 11/00; B65H 5/02

(52) U.S. Cl. CPC B41J 13/08; B41J 11/0015; B41J 11/0095; B65H 5/021; B65H 2404/27; B65H 2404/28; B65H 2553/40

(57) ABSTRACT

A multilayer belt includes a metal layer formed in an endless shape, a resin layer provided at the metal layer, and a low reflective layer provided at least partially between the metal layer and the resin layer, and having a light reflectance lower than that of the metal layer.

The present application is based on, and claims priority from JP Application Serial Number 2023-200479, filed Nov. 28, 2023, and 2023-200539, filed Nov. 28, 2023, the disclosures of which are hereby incorporated by reference herein in its entirety.

### BACKGROUND

### 1. Technical Field

The present disclosure relates to a multilayer belt, a medium transport device, and a recording device.

### 2. Related Art

JP 2009-174058 A discloses a metal belt and a coated belt each having a long life and excellent durability.

The metal belt described in JP 2009-174058 A is formed in an endless shape by an electroforming process using a nickel electrolytic bath containing a primary brightener and a secondary brightener, and has a crystal orientation in which a crystal orientation ratio I(200)/I(111) is from 113 to 250. Further, the metal belt contains nickel as a main component and does not contain manganese. The above primary brightener is an organic compound having a structure of =C-SO2-, and the secondary brightener is an organic compound having a structure of any one of C=O, C=C, C≡N, C═N, C≡C, N—C═S, N=N, and —CH2-CH—O—.

The above-described metal belt and coated belt are provided at a transport device as a transporting belt for transporting a predetermined transported object in some cases. The transport device is provided with a detection unit that detects a transported object in some cases. In the detection unit, an optical sensor may be used that detects presence or absence of the transported object by irradiating the transporting belt with light and receiving reflected light from the transported object.

However, when a metal belt and a coated belt as disclosed in JP 2009-174058 A are provided at a transport device including an optical sensor, there is a risk, in the transport device, that light from the optical sensor is reflected by gloss of a surface of the belt, and a problem occurs in detection of a transported object.

### SUMMARY

An aspect of the present disclosure is a multilayer belt including a metal layer formed in an endless shape, a resin layer provided at the metal layer, and a low reflective layer provided at least partially between the metal layer and the resin layer, and having a light reflectance lower than that of the metal layer.

Another aspect of the present disclosure is a medium transport device including a belt transport unit provided with the above multilayer belt and configured to transport a medium.

Still another aspect of the present disclosure is a recording device including a belt transport unit provided with the above multilayer belt and configured to transport a medium, and a recording unit configured to perform recording on the medium transported by the belt transport unit.

### BRIEF DESCRIPTION OF THE DRAWINGS

FIG. 1 is a side view of a main part illustrating each part related to a medium transport path of a printing apparatus.

FIG. 2 is a side view of a main part illustrating a transport device.

FIG. 3 is a perspective view of a transporting belt.

FIG. 4 is a cross-sectional view at a plane IV in FIG. 3.

FIG. 5 is a cross-sectional view at a plane V in FIG. 3.

FIG. 6 is an explanatory view illustrating manufacturing processes of the transporting belt.

FIG. 7 is a diagram illustrating an original fabric processing process.

FIG. 8 is a diagram illustrating a joining process.

FIG. 9 is a diagram illustrating a low reflective layer formation process.

FIG. 10 is a diagram illustrating a positioning portion cutting process.

### DESCRIPTION OF EMBODIMENTS

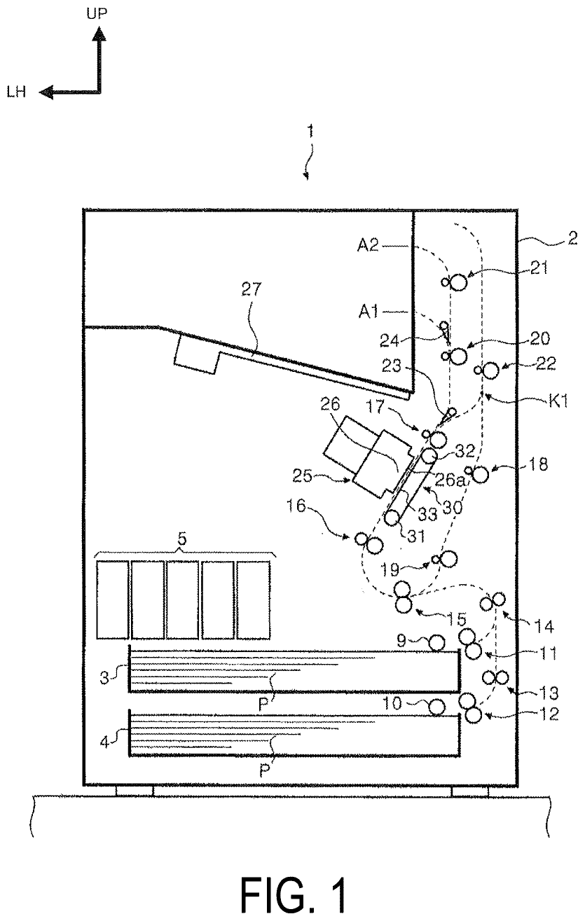

Embodiments of the present disclosure will be described below with reference to the accompanying drawings. Note that in the description, directions such as front, rear, left, right, up, and down are the same as directions with respect to a printing apparatus 1 in FIG. 1 unless otherwise specified. In addition, a reference sign UP illustrated in each drawing indicates an upper side of the printing apparatus 1 along a vertical direction, and a reference sign LH indicates a left side of the printing apparatus 1. A left-right direction and a front-rear direction of the printing apparatus 1 are directions orthogonal to each other and parallel to a horizontal direction.

FIG. 1 is a side view of a main part illustrating each part related to a medium transport path R of the printing apparatus 1. In FIG. 1, the medium transport path R is indicated by a dashed line.

As illustrated in FIG. 1, the printing apparatus 1 is an apparatus that ejects ink from a line-shaped inkjet head onto a recording sheet P which is a medium, to print characters and images on the recording sheet P. The printing apparatus 1 corresponds to a “recording device”.

In the printing apparatus 1, the recording sheet P is transported through the medium transport path R indicated by the dashed line. In the following description, a direction in which the recording sheet P is transported in the medium transport path R is referred to as a transport direction F.

The printing apparatus 1 includes an apparatus main body 2 which is a housing.

The apparatus main body 2 includes a first medium cassette 3 and a second medium cassette 4. Each of the first medium cassette 3 and the second medium cassette 4 functions as an accommodation unit that accommodates the recording sheet P. The first medium cassette 3 and the second medium cassette 4 are provided so as to be attachable to and detachable from the apparatus main body 2, from a front side.

The apparatus main body 2 is provided with a pick roller 9 that sends out the recording sheet P accommodated in the first medium cassette 3, and a pick roller 10 that sends out the recording sheet P accommodated in the second medium cassette 4.

The apparatus main body 2 is provided with a feeding roller pair 11 that sends out the recording sheet P sent out from the first medium cassette 3 in an obliquely upward direction, and a feeding roller pair 12 that sends out the recording sheet P sent out from the second medium cassette 4 in an obliquely upward direction. Further, the apparatus main body 2 is provided with a transport roller pair 13 that transports the recording sheet P sent out by the feeding roller pair 12 in an upward direction.

The apparatus main body 2 is provided with transport roller pairs 14, 15, and 16. The transport roller pairs 14, 15, and 16 are disposed above the feeding roller pair 11 and the transport roller pair 13. Each of the transport roller pairs 14, 15, and 16 transports the recording sheet P sent out from the feeding roller pair 11 or the transport roller pair 13 in order toward an upper portion of the apparatus main body 2.

Each of the feeding roller pairs 11, 12, and the transport roller pairs 13, 14, 15, and 16 includes a driving roller driven by a motor and a driven roller that is driven to rotate in contact with the driving roller. Each of the feeding roller pairs 11, 12, and the transport roller pairs 13, 14, 15, and 16 transports the recording sheet P sandwiched between the driving roller and the driven roller in the transport direction F by rotation of the driving roller and the driven roller.

In the following description, a “roller pair” includes a driving roller and a driven roller, similarly to the feeding roller pairs 11, 12, and the transport roller pairs 13, 14, 15, and 16, and these rollers nip and transport the recording sheet P.

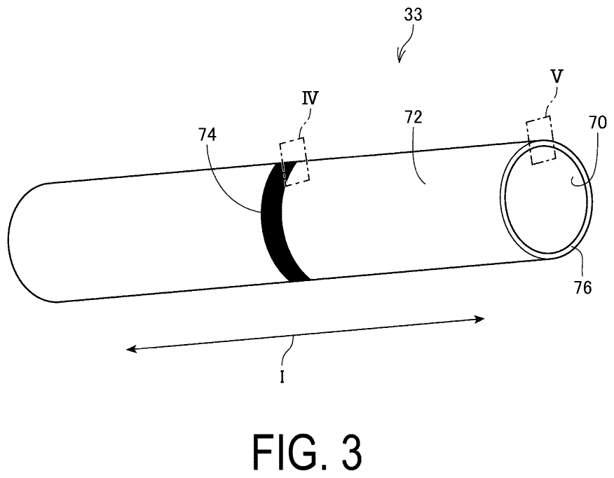

The upper portion of the apparatus main body 2 is provided with a head unit 25. The head unit 25 includes a line head 26 that sprays a predetermined ink. The line head 26 is a line inkjet head capable of spraying ink without performing scanning. The line head 26 includes an ink ejection surface 26a which is a flat surface. At the ink ejection surface 26a, a plurality of nozzles for spraying ink are arranged along an orthogonal direction I which is a direction orthogonal to the transport direction F. The orthogonal direction I is a direction orthogonal to an up-down direction and the left-right direction of the printing apparatus 1. The orthogonal direction I is illustrated in FIG. 3 to be described later.

Note that the nozzles provided at the ink ejection surface 26a may be disposed side by side not only in the direction orthogonal to the transport direction F but also in a direction obliquely intersecting the transport direction F.

A row of the nozzles provided at the ink ejection surface 26a is formed at least as wide as or wider than a printable range of the recording sheet P.

The apparatus main body 2 is provided with an ink accommodation portion 5 that accommodates ink. Ink ejected from the line head 26 is supplied from the ink accommodation portion 5 to the line head 26 via a flow path formed by a tube or the like. The ink accommodation portion 5 includes a plurality of ink tanks.

The head unit 25 and the ink accommodation portion 5 correspond to a “recording unit”.

The apparatus main body 2 is provided with a transport device 30.

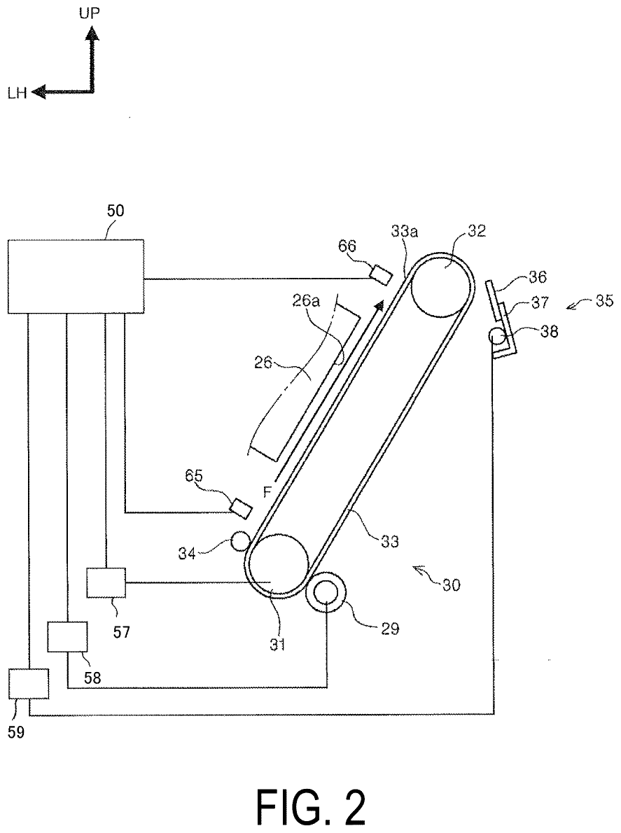

The transport device 30 includes a transporting belt 33, a driving pulley 31, and a driven pulley 32. The transporting belt 33 is an endless belt wound around the driving pulley 31 and the driven pulley 32. The transporting belt 33 is rotated by the driving pulley 31 being driven by a belt driving motor 57. The belt driving motor 57 is illustrated in FIG. 2 to be described later. The belt driving motor 57 may be an actuator such as a motor.

The transport device 30 corresponds to a “medium transport device”.

The transporting belt 33 is wound around the driving pulley 31 and the driven pulley 32 to form a flat surface portion. The transporting belt 33 is disposed such that the flat surface portion faces the ink ejection surface 26a in parallel. A circumferential surface of the transporting belt 33 rotates along the transport direction F. A width direction of the transporting belt 33 coincides with the orthogonal direction I which is the direction orthogonal to the transport direction F.

The recording sheet P is fed to a gap between the line head 26 and the transporting belt 33 by each of the transport roller pairs 14, 15, and 16. The recording sheet P is adsorbed by the transporting belt 33, and is transported by the transporting belt 33 in a state in which one surface of the recording sheet P is held at a position facing the ink ejection surface 26a. Then, ink is ejected from each of the nozzles of the ink ejection surface 26a onto the one surface of the recording sheet P transported by the transporting belt 33, to perform recording.

In this case, a width direction of the recording sheet P coincides with the orthogonal direction I on a surface of the recording sheet P.

After recording is performed on the one surface by the line head 26, the recording sheet P is fed in the upward direction by a transport roller pair 17 positioned downstream of the transporting belt 33.

A flap 23 is provided downstream of the transport roller pair 17. In the printing apparatus 1, transport path of the recording sheet P is switched by the flap 23.

The upper portion of the apparatus main body 2 is provided with a discharge position A1 where the recording sheet P is discharged from an inside of the apparatus main body 2 to an outside of the apparatus main body 2, and a discharge position A2.

When the recording sheet P is discharged after recording is performed on the one surface, the medium transport path R is switched by the flap 23 to a path toward the transport roller pair 20 on the upper side.

A flap 24 is provided downstream of the transport roller pair 20. The medium transport path R is switched by the flap 24 to either a path for discharging the recording sheet P from the discharge position A1 or a path for transporting the recording sheet P to a transport roller pair 21 positioned vertically above the flap 24.

The recording sheet P discharged from the discharge position A1 is received by a discharge tray 27 provided at the apparatus main body 2.

When the recording sheet P is fed toward the transport roller pair 21, the recording sheet P is discharged from the discharge position A2. The recording sheet P discharged from the discharge position A2 is received by an optional tray or the like, for example.

When recording is performed on another surface in addition to the one surface of the recording sheet P, the recording sheet P is fed in the upward direction by the flap 23, passes through a branch position K1, and is fed from the branch position K1 to a switch-back path on the upper side. The switch-back path is provided with a transport roller pair 22. The recording sheet P transported to the switch-back path is transported in the upward direction by the transport roller pair 22. In the printing apparatus 1, when an upstream end of the recording sheet P passes through the branch position K1, a rotation direction of the transport roller pair 22 is switched. As a result, the recording sheet P is transported in a downward direction.

In the apparatus main body 2, transport roller pairs 18 and 19 are provided between the transport roller pair 22 and the transport roller pair 15. When the recording sheet P is transported in the downward direction by the transport roller pair 22, the recording sheet P is sent out by the transport roller pairs 18 and 19, and reaches the transport roller pairs 15 and 16. The recording sheet P is fed to the transporting belt 33 again by the transport roller pairs 15 and 16.

In this case, the other surface of the recording sheet P faces the line head 26. This makes recording by the line head 26 possible on the other surface of the recording sheet P, in the printing apparatus 1. When recording is performed on the other surface, the recording sheet P is discharged from the above-described discharge position A1 or the discharge position A2.

Next, the transport device 30 will be described.

FIG. 2 is a side view of a main part illustrating the transport device 30.

As illustrated in FIG. 2, the transporting belt 33 constituting the transport device 30 is an endless belt formed by imparting an insulating material to a base material formed of a metal material.

The transporting belt 33 is wound around the driving pulley 31 positioned upstream and the driven pulley 32 positioned downstream in the medium transport path R.

Predetermined tension is imparted to the transporting belt 33 by a tensioner or the like. As a result, a flat surface is formed at the transporting belt 33 at a position facing the ink ejection surface 26a.

The driving pulley 31 is rotationally driven by the belt driving motor 57. When the driving pulley 31 is rotationally driven in an arrow direction, the transporting belt 33 rotates in a clockwise direction in FIG. 2. In the transport device 30, the driven pulley 32 is rotated along with the rotation of the transporting belt 33.

Each of the driving pulley 31 and the driven pulley 32 is a rod-shaped member disposed such that a longitudinal direction thereof extends along the orthogonal direction I. A length dimension in the longitudinal direction of each of the driving pulley 31 and the driven pulley 32 is formed to be longer than a width dimension which is a dimension in a direction along the orthogonal direction I of the transporting belt 33.

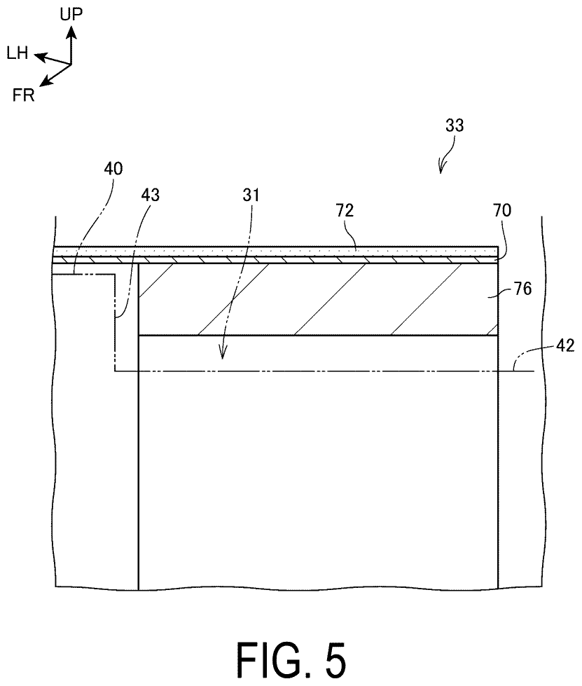

As illustrated in FIG. 5 described later, each of the driving pulley 31 and the driven pulley 32 is provided with a large diameter portion 40 and a small diameter portion 42. The large diameter portion 40 is provided at a central portion in the longitudinal direction of each of the driving pulley 31 and the driven pulley 32. The small diameter portions 42 are provided at both ends in the longitudinal direction of each of the driving pulley 31 and the driven pulley 32, and are each formed to have a diameter dimension smaller than that of the large diameter portion 40. The large diameter portion 40 is entirely covered with the transporting belt 33, and at least both end portions of the small diameter portions 42 protrude outward from the transporting belt 33.

A portion positioned between the large diameter portion 40 and the small diameter portion 42 is provided with an abutting portion 43 which is a stepped surface formed by a difference in diameter dimension between the large diameter portion 40 and the small diameter portion 42. The abutting portion 43 is a flat surface orthogonal to the orthogonal direction I.

Note that a support plate that supports the transporting belt 33 may be provided inside the transporting belt 33. The support plate is a plate member including a flat surface facing the ink ejection surface 26a. Since the transporting belt 33 is supported by the support plate from an inner side, a stable flat surface for which bending is regulated may be formed at the transporting belt 33 at a position facing the ink ejection surface 26a.

In the transport device 30, a charging roller 29 is provided at a position facing the driving pulley 31 with the transporting belt 33 interposed therebetween.

The charging roller 29 is in contact with an outer surface of the transporting belt 33 and is driven to rotate in accordance with the rotation of the transporting belt 33. A DC voltage is applied to the charging roller 29 by a belt charging unit 58. As a result, the charging roller 29 supplies an electric charge to a portion in contact with the transporting belt 33 to generate electrostatic force.

In the present embodiment, the charging roller 29 supplies a positive electric charge to the transporting belt 33 to charge an outer peripheral surface 33a of the transporting belt 33 with a positive polarity. As a result, the outer peripheral surface 33a of the transporting belt 33 serves as an adsorbing surface for adsorbing the recording sheet P. That is, the recording sheet P transported by the transporting belt 33 is held by the transporting belt 33 by so-called electrostatic adsorption.

The charging roller 29 corresponds to a “charging unit”.

A support roller 34 that comes into contact with a medium is provided upstream of the line head 26. The support roller 34 presses the recording sheet P against a portion of the transporting belt 33 wound around the driving pulley 31. The support roller 34 is disposed so as to come in contact with the recording sheet P.

When an electric charge is imparted to the outer peripheral surface 33a of the transporting belt 33 by the charging roller 29, an electric charge having an opposite polarity is generated at a surface of the recording sheet P in contact with the outer peripheral surface 33a. At a surface opposite to the surface in contact with the outer peripheral surface 33a, that is, at a recording surface of the recording sheet P on which recording is performed, an electric charge having a polarity opposite to that of a charge generated at the surface in contact with the outer peripheral surface 33a is generated.

In the present embodiment, when the support roller 34 comes into contact with the recording surface of the recording sheet P, the electric charge on the recording surface side of the recording sheet P is removed. As a result, only the electric charge on the side in contact with the transporting belt 33 remains at the recording sheet P, and the recording sheet P is more strongly adsorbed to the outer peripheral surface 33a.

In addition, when the transport device 30 is driven without the recording sheet P being transported by the transporting belt 33, the support roller 34 abuts on the outer peripheral surface 33a. As a result, the electric charge at the outer peripheral surface 33a of the transporting belt 33 is removed.

An outer surface of the support roller 34 may be made of any material as long as the material can remove electric charges from the recording sheet P and the transporting belt 33. The outer surface of the support roller 34 is formed of a resin material such as conductive nylon.

Note that the support roller 34 may be caused to function as a friction imparting unit that causes the transporting belt 33 to be charged by friction.

In addition, the printing apparatus 1 may include a destaticizing brush or the like that comes into contact with the recording sheet P instead of the support roller 34.

The support roller 34 corresponds to a “destaticizing unit”.

The transport device 30 is provided with an upstream sensor 65 and a downstream sensor 66.

The upstream sensor 65 is provided at a position upstream of the line head 26 and facing the transporting belt 33 in the medium transport path R.

The downstream sensor 66 is provided at a position downstream of the line head 26 and facing the transporting belt 33 in the medium transport path R.

In the present embodiment, the upstream sensor 65 and the downstream sensor 66 are disposed substantially at a center in the width direction of the transporting belt 33 and at positions facing the transporting belt 33.

Note that the upstream sensor 65 and the downstream sensor 66 may each be disposed at any position in the width direction of the transporting belt 33 as long as the position faces the transporting belt 33. In addition, for example, a plurality of the upstream sensors 65 and a plurality of the downstream sensors 66 may be disposed along the width direction of the transporting belt 33.

Each of the upstream sensor 65 and the downstream sensor 66 is an optical sensor including a light-emitting unit that emits light toward the transporting belt 33 and a light-receiving unit that receives reflected light that is light emitted from the light-emitting unit and reflected by the recording sheet P. The light-emitting unit is a light-emitting element, for example. The light-receiving unit is, for example, a photoreceptor element.

A cleaning unit 35 is provided at a position adjacent to the driven pulley 32. The cleaning unit 35 includes a blade 36 that is a cleaning member that cleans the outer peripheral surface 33a of the transporting belt 33.

The blade 36 is a plate-shaped elastic member formed of, for example, urethane or rubber and having a predetermined thickness. The blade 36 is elastically deformable while being in contact with the transporting belt 33. A tip portion of the blade 36 cleans the outer peripheral surface 33a of the transporting belt 33 by coming into contact with a portion of the transporting belt 33 wound around the driven pulley 32.

The blade 36 is fixed to a fixing member 37. The fixing member 37 is provided to be rotatable about a rotary shaft 38.

The rotary shaft 38 is rotationally driven by a blade driving unit 59. In the cleaning unit 35, a contact state in which the blade 36 is in contact with the transporting belt 33 and a separation state in which the blade 36 is separated from the transporting belt 33 are switched by the rotation of the rotary shaft 38.

The blade driving unit 59 may be an actuator such as a motor.

In the cleaning unit 35, when the transporting belt 33 rotates forward in the contact state of the blade 36, attached matter such as ink or paper dust attached to the outer peripheral surface 33a of the transporting belt 33 is removed.

Note that the cleaning unit 35 may be, for example, a belt-shaped fabric or the like formed to be capable of being rotationally driven.

The belt driving motor 57, the belt charging unit 58, and the blade driving unit 59 described above are controlled by a control unit 50 being a controller.

The control unit 50 is a controlling unit that controls the entire printing apparatus 1. The control unit 50 controls medium transport motors that drive the line head 26 and the roller pair, and the like.

The control unit 50 includes a CPU, a ROM, a RAM, and the like as an operation execution unit. The ROM of the control unit 50 stores firmware executable by the CPU, data related to the firmware, and the like in a nonvolatile manner. In addition, the RAM temporarily stores the data related to the firmware executed by the CPU. The control unit 50 may include other peripheral circuits and the like. The control unit 50 may include a storage unit capable of storing various programs and data such as control programs and data related to the control programs in a nonvolatile manner.

The control unit 50 controls the belt charging unit 58, to switch ON/OFF of voltage application to the charging roller 29, and switch a voltage value to apply to the charging roller 29.

The control unit 50 controls the blade driving unit 59 to adjust a rotation amount of the rotary shaft 38, thereby adjusting pressing force when the blade 36 is pressed against the transporting belt 33.

Detection signals from various sensors are input to the control unit 50. The control unit 50 performs necessary control based on the detection signals.

By acquiring a detection signal of the upstream sensor 65, the control unit 50 can detect passage of a leading end of the recording sheet P or a trailing end of the recording sheet P at a position of the upstream sensor 65. By acquiring a detection signal of the downstream sensor 66, the control unit 50 can detect passage of the leading end of the recording sheet P or the trailing end of the recording sheet P at a position of the downstream sensor 66.

Next, the transporting belt 33 will be described in detail.

FIG. 3 is a perspective view of the transporting belt 33.

As illustrated in FIG. 3, the transporting belt 33 is a belt member formed in an endless shape. The transporting belt 33 is formed in a substantially cylindrical shape as a whole. When attached to the transport device 30, the transporting belt 33 is disposed such that the longitudinal direction extends along the orthogonal direction I. The longitudinal direction of the transporting belt 33 is the width direction of the transporting belt 33 described above.

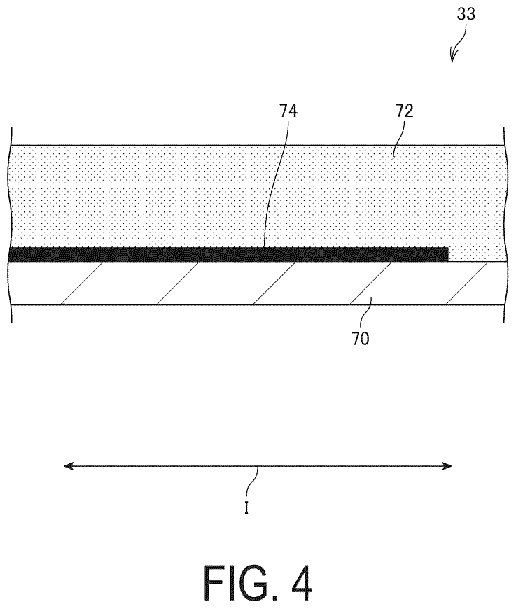

FIG. 4 is a cross-sectional view illustrating a cross section at the plane IV in FIG. 3. The plane IV is a plane orthogonal to a circumferential surface of the transporting belt 33 substantially at a center in the longitudinal direction of the transporting belt 33. The plane IV is a plane parallel to the longitudinal direction of the transporting belt 33 and the orthogonal direction I.

As illustrated in FIG. 4, the transporting belt 33 is a multilayer belt formed by overlaying a plurality of materials in a layered manner.

The transporting belt 33 includes a metal layer 70. The metal layer 70 is a base material formed of a metal material, and formed over the entire longitudinal direction and an entire circumferential direction of the transporting belt 33. That is, the metal layer 70 is a so-called coil material formed in a substantially cylindrical shape as a whole.

In the present embodiment, an austenitic stainless material is used for the metal layer 70. For the metal layer 70, for example, SUS304H, SUS304 1/2H, SUS304 3/4H, SUS301 1/2H, SUS301 3/4H, SUS301H, SUS301EH, SUS632J1 or the like may be used.

As described above, in the transporting belt 33, a material that is inexpensive and has high workability can be used for the metal layer 70, and productivity can be improved.

Here, in the printing apparatus 1, the transporting belt 33 is used at a predetermined temperature in accordance with driving of the transport device 30 and each unit of the printing apparatus 1. As described above, the transporting belt 33 is held in a state of being rotationally driven or stopped by the transport device 30 in a state where the driving pulley 31 and the driven pulley 32 are inserted and tension is applied.

In a case where a base material of the transport belt 33 is a resin material, when the transporting belt 33 is held in the stopped state for a predetermined period of time, there is a risk that the transporting belt 33 has a tendency in the held state, that is, a so-called creep deformation occurs. Therefore, when the base material of the transporting belt 33 is a resin material, the transport device 30 needs to be provided with a mechanism for suppressing the creep deformation, such as a mechanism for releasing tension.

Since a metal material is used as the base material, the transporting belt 33 of the present embodiment has higher heat resistance than, for example, when a resin material is used as the base material, and viscosity is less likely to occur at a temperature at which the printing apparatus 1 is used.

As a result, in the transport device 30, it is not necessary to release tension, and it is not necessary to provide a mechanism for suppressing a creep deformation.

Further, since a metal material is used as the base material, the transporting belt 33 of the present embodiment has predetermined rigidity. For this reason, in the transporting belt 33, occurrence of bending is suppressed without providing a support plate or the like, and a stable flat surface can be formed at a position facing the ink ejection surface 26a.

In addition, even when a support plate is provided, it is possible to suppress wear of the transporting belt 33 caused by sliding on the support plate.

As described above, since the transport device 30 includes the transporting belt 33, it is possible to simplify the device configuration.

The transporting belt 33 includes a blackened layer 74. The blackened layer 74 is a layer having a black color capable of absorbing light emitted from the upstream sensor 65 and the downstream sensor 66.

In the present embodiment, the blackened layer 74 is provided over an entire circumferential direction of the metal layer 70.

The blackened layer 74 has a predetermined width dimension along the longitudinal direction of the transporting belt 33. In the present embodiment, the blackened layer 74 has a width dimension large enough to overlap an entire irradiation range of a light-emitting sensor.

The blackened layer 74 is provided at an outer surface of the metal layer 70. The blackened layer 74 is disposed substantially at a center in the longitudinal direction of the transporting belt 33. As a result, the blackened layer 74 is disposed to face each of the upstream sensor 65 and the downstream sensor 66.

For the blackened layer 74, a resin paint such as a polyester paint, an acrylic paint, a urethane paint, a silicone paint, or a fluorine paint is used. In addition, for example, the blackened layer 74 is not limited to a paint, and a black tape, a film material, or the like may be used.

Note that the transporting belt 33 is not limited to the blackened layer 74, and may be provided with any processed layer as long as the processed layer is a low reflective layer having a reflectance lower than that of a medium such as the recording sheet P, or the outer surface of the metal layer 70.

In addition, for example, the blackened layer 74 may be partially provided in the circumferential direction of the transporting belt 33, for example, in a broken line shape or the like, according to the structures or functions of the upstream sensor 65 and the downstream sensor 66, or a shape or type of a medium.

Further, for example, the blackened layer 74 may be provided at any position in the longitudinal direction of the transporting belt 33. Further, for example, a plurality of the blackened layers 74 may be provided in a row along the longitudinal direction of the transporting belt 33.

As a result, the blackened layer 74 can be provided only at a necessary portion of the transporting belt 33. For this reason, with such a transporting belt 33, productivity can be improved.

The blackened layer 74 corresponds to the “low reflective layer”.

The transporting belt 33 includes a resin layer 72. The resin layer 72 is a layer that has insulating properties, is formed of a transparent or translucent resin material, and covers the entire outer surface of the metal layer 70.

For the resin layer 72, a resin material having wear resistance, low friction properties, creep resistance, ink resistance, ink repellency, and adhesiveness is used.

As the resin material used for the resin layer 72, a fluorine-based resin, polypropylene, polyamide, polyethylene terephthalate, polyethylene, an aromatic polyether ketone such as polyether ether ketone, a cycloolefin-based resin such as a cycloolefin polymer or a cycloolefin copolymer, an epoxy resin, silicone, or the like may be used.

The resin layer 72 is formed by applying the above-described resin material to the entire outer surface of the metal layer 70 by, for example, electrostatic powder coating.

Since the resin layer 72 is formed, in the transporting belt 33, electrostatic force can be generated by the charging roller 29. Therefore, the transporting belt 33 can hold the recording sheet P.

As described above, the transporting belt 33 is formed by providing the resin layer 72 at the outer surface of the metal layer 70. That is, the transporting belt 33 is formed of two materials different in melting temperature, chemical resistance, and the like.

As a result, the transporting belt 33 is prevented from being restricted by temperature and chemical resistance in a manufacturing process, and can be manufactured at lower cost or by an easier manufacturing method. In addition, since the transporting belt 33 is formed of the metal layer 70 and the resin layer 72, the metal layer 70 and the resin layer 72 can be easily separated from each other. Therefore, the transporting belt 33 can be easily reused.

Further, since the resin layer 72 is provided at the outer surface of the metal layer 70 of the transporting belt 33 as described above, a creep deformation of the resin layer is suppressed. As a result, in the transporting belt 33, the resin layer 72 can be formed to have an increased thickness dimension. For this reason, in the transporting belt 33, it is possible to improve the insulating properties of the resin layer 72 which is an insulating layer, to suppress wear or the like due to friction with the recording sheet P or the like, and to improve durability of the resin layer 72.

Since the resin layer 72 is transparent or translucent, light emitted from the upstream sensor 65 and light emitted from the downstream sensor 66 pass through the resin layer 72. As a result, when the recording sheet P is not held by the transporting belt 33, the emitted light reaches the blackened layer 74. Therefore, the light reaching the blackened layer 74 is not reflected but absorbed, and the control unit 50 can detect that the recording sheet P is not held by the transporting belt 33 via the light-receiving unit.

Note that when the recording sheet P is held by the transporting belt 33, the blackened layer 74 is covered with the recording sheet P. Therefore, light emitted from the light-emitting unit is reflected by the recording surface of the recording sheet P. The light reflected by the recording surface of the recording sheet P is received by the light-receiving unit, and a predetermined signal is transmitted to the control unit 50. As a result, the control unit 50 can detect that the recording sheet P is held by the transporting belt 33 via the light-receiving unit.

As described above, the blackened layer 74 is provided over the entire circumferential direction of the transporting belt 33. As a result, in the printing apparatus 1, it is possible to detect whether the recording sheet P is held by the transporting belt 33 over the entire circumferential direction of the transporting belt 33 or not.

FIG. 5 is a cross-sectional view illustrating a cross section at the plane V in FIG. 3. The plane V is a plane orthogonal to the circumferential surface of the transporting belt 33 at one end portion in the longitudinal direction of the transporting belt 33. The plane V is a plane parallel to the longitudinal direction of the transporting belt 33 and the orthogonal direction I. In FIG. 5, the driving pulley 31 is indicated by a two-dot chain line for convenience of description.

As illustrated in FIG. 3, beads 76 are provided at both end portions in the longitudinal direction of the transporting belt 33. The bead 76 is an elongated plate member having a predetermined thickness dimension and a predetermined width dimension. As illustrated in FIG. 5, the beads 76 are provided at an inner surface of the metal layer 70 over an entire circumferential direction at both the end portions of the transporting belt 33 in the longitudinal direction. That is, the bead 76 is an annular protruding portion protruding from the inner surface of the metal layer 70.

As described above, the transporting belt 33 is attached to the transport device 30 in a state in which the driving pulley 31 and the driven pulley 32 are inserted therein.

In the transport device 30, the transporting belt 33 may meander during driving. In this case, it is possible to return the transporting belt 33 to a position before the transporting belt 33 meanders by the abutting portions 43 included in the driving pulley 31 and the driven pulley 32 coming into contact with the beads 76.

Since the transporting belt 33 of the present embodiment includes the metal layer 70 as the base material, even when the abutting portion 43 abuts on the bead 76 and then presses the bead 76, occurrence of bending at the end portion of the transporting belt 33 is suppressed.

In this way, the bead 76 functions as a meandering prevention portion of the transporting belt 33.

Note that the bead 76 may be provided at any position in the longitudinal direction of the transporting belt 33 without being limited to both the end portions in the longitudinal direction of the transporting belt 33.

For example, the bead 76 may be disposed substantially at a center in the longitudinal direction of the transporting belt 33. In this case, a groove shape having a width dimension capable of accommodating the bead 76 inside may be provided over an entire circumference substantially at a center of each of the driving pulley 31 and the driven pulley 32. The beads 76 abut on inner side surfaces of these groove shapes to correct the meandering of the transporting belt 33.

Next, manufacturing processes of the transporting belt 33 will be described.

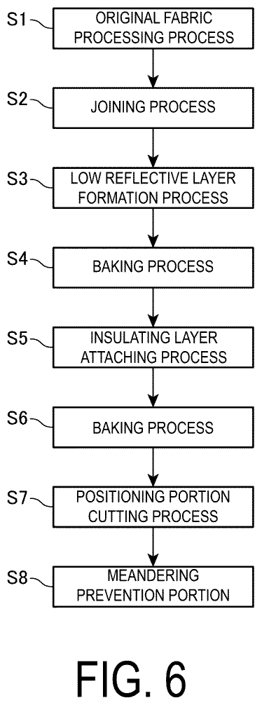

FIG. 6 is an explanatory view of the manufacturing processes of the transporting belt 33. FIG. 6 is a diagram illustrating an outline of the manufacturing processes of the transporting belt 33, divided by main contents. FIG. 6 does not limit details of the manufacturing processes of the transporting belt 33. For example, a process illustrated as a single step in FIG. 6 may include a plurality of detailed processes. The order of the processes illustrated in FIG. 6 may be interchanged as appropriate. In addition, in the manufacturing processes of the transporting belt 33, it is not excluded that a process not illustrated in FIG. 6 is performed.

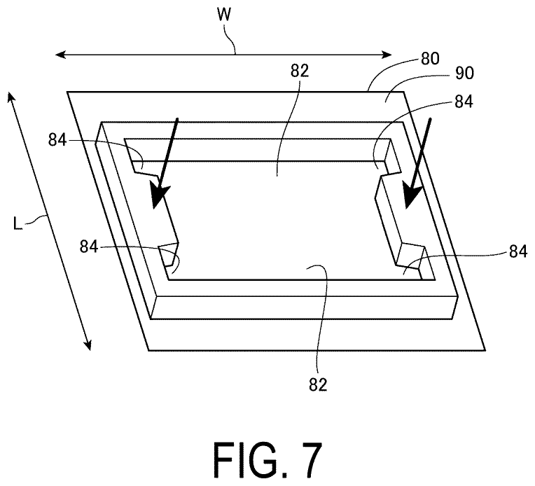

FIG. 7 is a diagram illustrating an original fabric processing process.

Step S1 illustrated in FIG. 6 is the original fabric processing process.

In the original fabric processing process, a plate-shaped or sheet-shaped metal material 80 serving as a raw material of the metal layer 70 is subjected to original fabric processing. As illustrated in FIG. 7, in the present embodiment, an original fabric 82 is formed by applying press working to the metal material 80 with a compound die 90. The original fabric 82 corresponds to the metal layer 70. The original fabric 82 is a flat plate-like member formed in a substantially rectangular shape in plan view. The original fabric 82 has predetermined length dimensions along a first direction and a second direction. The first direction and the second direction are directions orthogonal to each other. In the following description, the first direction is referred to as a length direction L, and the second direction is referred to as a width direction W.

In the original fabric 82, at both end portions 82 in the length direction L, positioning portions 84 are provided along the width direction W so as to protrude outward from both ends in the width direction by predetermined dimensions. The positioning portion 84 may be provided with a through-hole penetrating in a plate thickness direction.

Note that in the original fabric processing process, not only press working but also other processing methods such as laser cutting, wire electric discharge processing, etching processing, punching processing using a Thomson die, shearing processing, cutting processing, and grinding processing may be used.

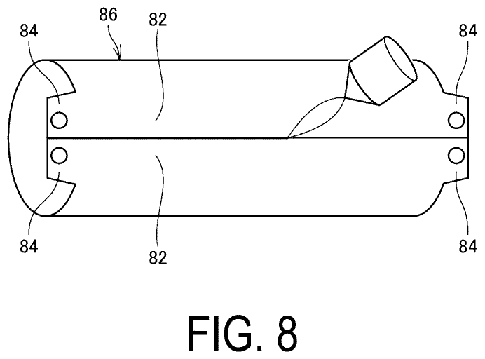

FIG. 8 is a diagram illustrating a joining process.

Step S2 is the joining process.

As illustrated in FIG. 8, in the joining process, both ends of the original fabric 82 in the length direction L are butted against each other by bending the original fabric 82 into a cylindrical shape such that the length direction L becomes a circumferential direction. Next, in the joining process, both the ends of the original fabric 82 in the length direction L are laser-welded from an outer surface side of the cylindrical original fabric 82 in a state where no step is formed. Specifically, fiber laser welding is used.

As a result, the original fabric 82 is formed into an endless belt shape. In the following description, the original fabric 82 that is welded and formed into a belt shape is referred to as a metal belt 86.

In the joining process, both the ends of the original fabric 82 in the length direction L can be more accurately and easily butted against each other by holding the original fabric 82 by each of the positioning portions 84. As described above, in the manufacturing processes of the transporting belt 33, since high-precision processing is performed in which both the ends of the original fabric 82 in the length direction L are laser-welded, it is possible to suppress variations in belt dimensions.

In addition, in the manufacturing processes of the transporting belt 33, the metal belt 86 is formed without processing a flat surface of the original fabric 82 in the original fabric processing process and the joining process. Thus, in the manufacturing processes of the transporting belt 33, an outer surface of the metal belt 86 is prevented from being deformed or damaged due to processing.

Note that in the joining process, not only fiber laser welding but also CO2 laser welding, YAG laser welding, disk laser welding, semi-conductor laser welding, or the like may be used.

In addition, for example, in the joining process, electron beam welding, arc welding, friction stir welding, ultrasonic welding, friction welding bonding, bonding using an adhesive, or brazing bonding may be used.

In addition, for example, in the joining process, both the ends of the original fabric 82 in the length direction L may be welded using mash seam welding, and then a level difference generated at a joining portion may be crushed to be smoothed. In addition, for example, in the joining process, both the ends of the original fabric 82 in the length direction L may be edge-joined and then subjected to a process of returning to a flat surface.

In addition, for example, in the joining process, both the ends of the original fabric 82 in the length direction L may be joined using a mechanical joining method such as rivet joining, snap fit joining, flange joining, or fitting and fixing.

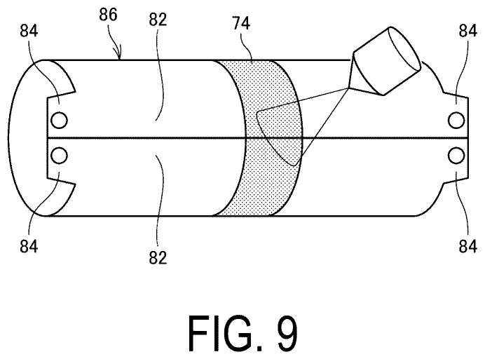

FIG. 9 is a diagram illustrating a low reflective layer formation process.

Step S3 is the low reflective layer formation process.

In the low reflective layer formation process, a black resin coating material is applied to a substantial center in the longitudinal direction of the metal belt 86. In the low reflective layer formation process, a polyester-based paint is applied to the outer surface of the metal belt 86 by spray coating.

As a result, the blackened layer 74 is formed at the outer surface of the metal belt 86.

Note that in the low reflective layer formation process, the blackened layer 74 may be partially provided in a circumferential direction of the metal belt 86, for example, in a broken line shape or the like.

Further, for example, in the low reflective layer formation process, the blackened layer 74 may be provided at any position in the longitudinal direction of the transporting belt 33. Further, for example, in the low reflective layer formation process, a plurality of the blackened layers 74 may be provided in a row along the longitudinal direction of the transporting belt 33.

As a result, the blackened layer 74 can be provided only at a necessary portion of the transporting belt 33. For this reason, with such a transporting belt 33, productivity can be improved.

Note that in the low reflective layer formation process, for example, various paints such as acrylic paints, urethane paints, silicone paints, and fluorine paints may be used as the resin paint.

These resin paints may be applied by powder coating, roller coating, dispenser coating, brush coating, or the like.

In addition, for example, the blackened layer 74 may be formed by plating treatment such as transfer film, black nickel plating, gunmetal plating, chromate treatment, or ceramic coating.

In addition, for example, the blackened layer 74 may be formed by various types of vapor deposition such as physical vapor deposition or chemical vapor deposition, or printing such as electrodeposition, laser coloring, ink jet, relief printing, intaglio printing, stencil printing, transfer printing, or offset printing.

The low reflective layer formation process may be performed before the joining process.

Step S4 is a baking process.

In the baking process, by performing baking, the blackened layer 74 is fixed to the metal belt 86.

Step S5 is an insulating layer attaching process.

In the insulating layer attaching process, the metal belt 86 is coated with a resin material by electrostatic powder coating in order to impart insulating properties. As a result, the resin layer 72 is formed at the metal belt 86. The outer surface of the metal belt 86 and the blackened layer 74 are covered with the resin layer 72.

In this way, in the manufacturing processes of the transporting belt 33, by forming the resin layer 72 by electrostatic powder coating, it is possible to suppress variations in the thickness dimension of the resin layer 72.

In addition, since the resin layer 72 is formed at the transporting belt 33 by electrostatic powder coating, adhesion occurs due to an anchor effect. Therefore, in the transporting belt 33, the resin layer 72 can be peeled off from the metal layer 70 at the time of reuse or the like.

Note that as a coating method of the resin material, a corona charging type electrostatic spraying method, a friction charging type electrostatic spraying method, a fluidized dipping method, an electrostatic fluidized dipping method, or the like may be used.

In addition, as a coating method of the resin material, spray coating, brush coating, coating using a dispenser, coating using an ink jet device, dipping, or the like may be used. In this case, the resin material is not limited to powder but may be liquid such as a resin liquid.

Further, the resin layer 72 may be formed by attaching a resin material formed in a sheet shape, attaching a heat-shrinkable tube, or electrodepositing a resin material.

Step S6 is a baking process.

In the baking process, baking is performed to fix the resin layer 72 to the metal belt 86.

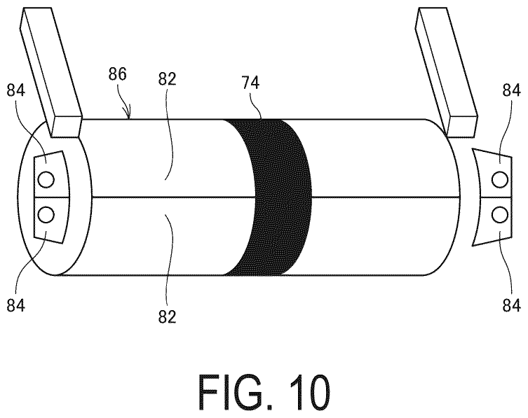

FIG. 10 is a diagram illustrating a positioning portion cutting process.

Step S7 is the positioning portion cutting process.

As illustrated in FIG. 10, in the positioning portion cutting process, each of the positioning portions 84 is cut. In the positioning portion cutting process, the positioning portion 84 is cut by press working, for example.

Further, for example, the positioning portion 84 may be cut by laser processing, wire electric discharge processing, or the like.

Step S8 is a meandering prevention portion formation process.

In the meandering prevention portion formation process, as illustrated in FIG. 3, the beads 76 are attached to an entire inner surface of the metal belt 86 in a circumferential direction at both end portions of the metal belt 86 in the longitudinal direction.

As a material of the bead 76, urethane rubber, natural rubber, nitrile rubber, silicon rubber, fluorine rubber, acrylic rubber, isoprene rubber, styrene rubber, butadiene rubber, butyl rubber, ethylene propylene rubber, ethylene propylene diene rubber, or the like may be used. Further, for example, ethylene vinyl acetate rubber, chloroprene rubber, hypalon rubber, chlorinated polyethylene rubber, epichlorohydrin rubber, polysulfide rubber, styrene-based elastomer, olefin-based elastomer, polyester-based elastomer, polyurethane-based elastomer, or the like may be used as the material of the bead 76.

In this way, the transporting belt 33 is manufactured by the manufacturing processes in steps S1 to S8. As a result, in the manufacturing processes of the transporting belt 33, the transporting belt 33 having high durability can be manufactured easily and accurately at low cost. Then, in the printing apparatus 1 including the transporting belt 33, it is possible to improve printing quality for the recording surface of the recording sheet P.

The embodiment described above merely represents one aspect of the present disclosure and any variation and application may be possible within the scope of the present disclosure.

In the above-described embodiment, the transport device 30 that transports the printing medium in the printing apparatus 1 as the recording device has been exemplified as the medium transport device. The transport device 30 is provided with the optical sensor including the light-emitting unit that emits light toward the transporting belt 33 and the light-receiving unit that receives reflected light that is light reflected from the transporting belt 33 side. However, the present disclosure is not limited to this, and the medium transport device can be applied to all transport devices that each transport any object as a medium and each have an optical sensor as described above.

In the embodiment described above, the printing apparatus 1 has been exemplified as the recording device. It is sufficient that the printing apparatus 1 is an apparatus that includes a transport device that transports a printing medium, and a printing unit that performs printing on the printing medium. For example, the printing apparatus 1 may be a large format printer, a textile printing machine that performs textile printing, or the like.

In the embodiment described above, the line head type including the line head 26 has been exemplified as the head unit 25, however, the present disclosure is not limited thereto, and a so-called serial head type that performs recording while moving in a width direction of a medium may be used. Further, the printing method of the head unit 25 is not limited to the ink jet method.

The directions such as the horizontal and vertical directions, the various numerical values, and the shapes in the above-described embodiment include so-called equivalent ranges for achieving the same operational effects as the directions, the numerical values, and the shapes unless otherwise specified.

### Overview of Present Disclosure

An overview of the present disclosure is added below.

### Supplementary Note 1

A multilayer belt including a metal layer formed in an endless shape, a resin layer provided at the metal layer, and a low reflective layer provided at least partially between the metal layer and the resin layer, and having a light reflectance lower than that of the metal layer.

As a result, the multilayer belt can be applied to an apparatus in which an optical sensor is used at a belt, so that a use range of the multilayer belt can be widened.

### Supplementary Note 2

The multilayer belt according to Supplementary Note 1, wherein the low reflective layer is provided at least partially in a direction intersecting a circumferential direction of the metal layer.

As a result, in the multilayer belt, the low reflective layer can be provided in a circumferential shape only at a necessary portion. Therefore, in the multilayer belt, productivity can be improved as compared with a case where the low reflective layer is provided at an entire belt.

### Supplementary Note 3

The multilayer belt according to Supplementary Note 1 or 2, wherein the low reflective layer is formed by being colored.

As a result, in the multilayer belt, the low reflective layer can be easily formed.

### Supplementary Note 4

The multilayer belt according to any one of Supplementary Note 1 to Supplementary Note 3, wherein the metal layer is formed of austenitic stainless steel.

As a result, it is possible to suppress magnetic influence when the multilayer belt is used in the apparatus.

### Supplementary Note 5

The multilayer belt according to any one of Supplementary Note 1 to Supplementary Note 4, wherein the resin layer is formed of a fluorine-based resin.

As a result, in the multilayer belt, a sheet can be electrostatically adsorbed by voltage application.

### Supplementary Note 6

A medium transport device including a belt transport unit provided with the multilayer belt according to any one of Supplementary Note 1 to Supplementary Note 5 and configured to transport a medium.

As a result, in the medium transport device, the multilayer belt according to any one of Supplementary Note 1 to Supplementary Note 5 is applicable as the transporting belt that transports the medium.

### Supplementary Note 7

The medium transport device according to Supplementary Note 6 including a charging unit configured to charge the multilayer belt, and a destaticizing unit configured to remove an electric charge at a surface of the medium adsorbed to the multilayer belt by charging of the charging unit.

With this configuration, in the medium transport device, the multilayer belt according to any one of Supplementary Note 1 to Supplementary Note 5 is applicable as a charging transporting belt.

### Supplementary Note 8

The medium transport device according to Supplementary Note 6 or Supplementary Note 7, including an optical sensor configured to detect presence or absence of the medium, wherein the optical sensor is provided at a position facing the low reflective layer, and the low reflective layer has a reflectance lower than that of a surface of the medium.

As a result, in the medium transport device, the presence or absence of the medium can be detected using the multilayer belt according to any one of Supplementary Note 1 to Supplementary Note 5.

### Supplementary Note 9

The medium transport device according to Supplementary Note 7 including an optical sensor configured to detect presence or absence of the medium, wherein the optical sensor is provided at a position facing the low reflective layer, and the low reflective layer has a reflectance lower than that of a surface of the medium.

As a result, in the medium transport device, the presence or absence of the medium can be detected using the multilayer belt according to any one of Supplementary Note 1 to Supplementary Note 5.

### Supplementary Note 10

A recording device including a belt transport unit provided with the multilayer belt according to any one of Supplementary Note 1 to Supplementary Note 5, and configured to transport a medium, and a recording unit configured to perform recording on the medium transported by the belt transport unit.

As a result, in the recording device, the multilayer belt according to any one of Supplementary Note 1 to Supplementary Note 5 is applicable as a transporting belt.

### Supplementary Note 11

The recording device according to Supplementary Note 10 including a charging unit configured to charge the multilayer belt, and a destaticizing unit configured to remove an electric charge at a surface of the medium adsorbed to the multilayer belt by charging of the charging unit, wherein the recording unit performs recording on the medium that passes through the destaticizing unit and is transported by the multilayer belt.

As a result, in the recording device, the multilayer belt according to any one of Supplementary Note 1 to Supplementary Note 5 is applicable as a charging transporting belt.

### Supplementary Note 12

The recording device according to Supplementary Note 10 or Supplementary Note 11 including an optical sensor configured to detect presence or absence of the medium, wherein the optical sensor is provided at a position facing the low reflective layer, and the low reflective layer has a reflectance lower than that of a surface of the medium.

As a result, in the recording device, the presence or absence of the medium can be detected using the multilayer belt according to any one of Supplementary Note 1 to Supplementary Note 5.

### Supplementary Note 13

The recording device according to Supplementary Note 11 including an optical sensor configured to detect presence or absence of the medium, wherein the optical sensor is provided at a position facing the low reflective layer, and the low reflective layer has a reflectance lower than that of a surface of the medium.

As a result, in the recording device, the presence or absence of the medium can be detected using the multilayer belt according to any one of Supplementary Note 1 to Supplementary Note 5.

### Supplementary Note 14

A manufacturing method of a belt in which a plate material formed of a metal material is formed into a cylindrical shape and end portions of the plate material are joined to form a metal layer in an endless shape.

As a result, in the manufacturing method of the belt, it is possible to manufacture a belt having high durability at lower cost than in the related art in both the material and the manufacturing method.

### Supplementary Note 15

The manufacturing method of the belt according to Supplementary Note 14, wherein the end portions of the plate material are joined by welding from an outer surface side.

As a result, in the manufacturing method of the belt, it is possible to easily and accurately join the metal materials.

### Supplementary Note 16

The manufacturing method of the belt according to Supplementary Note 14, wherein the end portions of the plate material are joined with an adhesive.

As a result, in the manufacturing method of the belt, the metal materials can be easily joined.

### Supplementary Note 17

The manufacturing method of the belt according to any one of Supplementary note 14 to Supplementary note 16, wherein a low reflective layer having a light reflectance lower than that of the metal layer is formed at least partially at an outer surface of the metal layer.

As a result, in the manufacturing method of the belt, it is possible to manufacture a belt that can be detected by an optical sensor, and it is possible to expand a range of use of the belt.

### Supplementary Note 18

The manufacturing method of the belt according to Supplementary Note 17, wherein the low reflective layer is formed at least partially at the outer surface of the metal layer in a direction intersecting a circumferential direction of the metal layer.

As a result, in the manufacturing method of the belt, it is possible to manufacture a belt that can be detected by an optical sensor at the belt in the entire circumferential direction, and it is possible to expand a range of use of the belt.

### Supplementary Note 19

The manufacturing method of the belt according to Supplementary Note 17 or Supplementary Note 18, wherein the low reflective layer is formed by applying a coloring material.

As a result, in the manufacturing method of the belt, the low reflective layer can be easily formed at the belt.

### Supplementary Note 20

The manufacturing method of the belt according to any one of Supplementary Note 14 to Supplementary Note 19, wherein resin is attached to the outer surface of the metal layer and baking is performed to form a resin layer.

As a result, in the manufacturing method of the belt, it is possible to manufacture a belt capable of electrostatically adsorbing a sheet by voltage application.

### Supplementary Note 21

The manufacturing method of the belt according to Supplementary Note 20, wherein the resin is attached to the metal layer by electrostatic powder coating.

As a result, in the manufacturing method of the belt, recycling of a powder coating material is facilitated, and a yield of a material relating to belt manufacturing is improved.

### Supplementary Note 22

The manufacturing method of the belt according to Supplementary Note 20, wherein a resin liquid is applied to attach the resin to the metal layer.

As a result, in the manufacturing method of the belt, the resin can be easily attached to the metal layer.

### Supplementary Note 23

The manufacturing method of the belt according to any one of Supplementary Note 1 to Supplementary Note 22, wherein the metal layer is formed of an austenitic stainless material.

As a result, in the manufacturing method of the belt, the metal layer can be easily formed by using a material that is inexpensive and has good workability.

### Supplementary Note 24

The manufacturing method of the belt according to any one of Supplementary Note 20 to Supplementary Note 22, wherein the resin layer is formed of a fluorine-based resin.

As a result, in the manufacturing method of the belt, the resin layer can be easily provided.

What is claimed is:

1. A multilayer belt, comprising:
a metal layer formed in an endless shape;
a resin layer provided at the metal layer; and
a low reflective layer provided at least partially between the metal layer and the resin layer, and having a light reflectance lower than that of the metal layer.

2. The multilayer belt according to claim 1, wherein
the low reflective layer is provided at least partially in a direction intersecting a circumferential direction of the metal layer.

3. The multilayer belt according to claim 1, wherein
the low reflective layer is formed by being colored.

4. The multilayer belt according to claim 1, wherein
the metal layer is formed of austenitic stainless steel.

5. The multilayer belt according to claim 1, wherein
the resin layer is formed of a fluorine-based resin.

6. A medium transport device comprising a belt transport unit provided with the multilayer belt according to claim 1 and configured to transport a medium.

7. The medium transport device according to claim 6, comprising:
a charging unit configured to charge the multilayer belt; and
a destaticizing unit configured to remove an electric charge at a surface of the medium adsorbed to the multilayer belt by charging of the charging unit.

8. The medium transport device according to claim 6 comprising an optical sensor configured to detect presence or absence of the medium, wherein
the optical sensor is provided at a position facing the low reflective layer, and
the low reflective layer has a reflectance lower than that of a surface of the medium.

9. The medium transport device according to claim 7 comprising an optical sensor configured to detect presence or absence of the medium, wherein
the optical sensor is provided at a position facing the low reflective layer, and
the low reflective layer has a reflectance lower than that of a surface of the medium.

10. A recording device, comprising:
a belt transport unit provided with the multilayer belt according to claim 1, and configured to transport a medium; and
a recording unit configured to perform recording on the medium transported by the belt transport unit.

11. The recording device according to claim 10, comprising:
a charging unit configured to charge the multilayer belt; and
a destaticizing unit configured to remove an electric charge at a surface of the medium adsorbed to the multilayer belt by charging of the charging unit, wherein
the recording unit performs recording on the medium that passes through the destaticizing unit and is transported by the multilayer belt.

12. The recording device according to claim 10 comprising an optical sensor configured to detect presence or absence of the medium, wherein
the optical sensor is provided at a position facing the low reflective layer, and
the low reflective layer has a reflectance lower than that of a surface of the medium.

13. The recording device according to claim 11 comprising an optical sensor configured to detect presence or absence of the medium, wherein
the optical sensor is provided at a position facing the low reflective layer, and
the low reflective layer has a reflectance lower than that of a surface of the medium.
